(19) United States
(12) Patent Application Publication
(10) Pub. No.: US 2025/0362724 A1
(43) Pub. Date: Nov. 27, 2025

(54) HEAT DISSIPATION APPARATUS

(71) Applicant: Lanto Electronic Limited, Kunshan City (CN)

(72) Inventors: CHIH HSIUNG CHANG, Kunshan City (CN); KUEI JUNG YANG, Kunshan City (CN); CIAO YIN YANG, Kunshan City (CN)

(73) Assignee: Lanto Electronic Limited, Kunshan City (CN)

(21) Appl. No.: 18/887,447

(22) Filed: Sep. 17, 2024

(30) Foreign Application Priority Data
May 21, 2024 (CN) 202410634414.3

(51) Int. Cl. G06F 1/20

(52) U.S. Cl. CPC G06F 1/203

(57) ABSTRACT

In a heat dissipation apparatus, a housing has a mounting cavity, as well as a first air outlet, a second air outlet, and a first air inlet that communicate with the mounting cavity. A gas supply member is disposed within the housing. An inlet end of a gas inlet tube abuts against the housing and communicates with the first air inlet, and an outlet end of the gas inlet tube communicates with a gas inlet vent of the gas supply member. A vortex tube has an expansion chamber, as well as a second air inlet, a cold air outlet and a hot air outlet that communicate with the expansion chamber. A gas outlet vent of the gas supply member communicates with the second air inlet, the cold air outlet communicates with the first air outlet, and the hot air outlet communicates with the second air outlet.

### CROSS-REFERENCE TO RELATED APPLICATION(S)

This application claims the priority to a Chinese Patent Application No. 202410634414.3, filed May 21, 2024, the disclosure of which is incorporated herein by reference in its entirety.

### TECHNICAL FIELD

The present disclosure relates to the field of heat dissipation technologies, and in particularly, to a heat dissipation apparatus.

### BACKGROUND

A gaming notebook computer is a computer designed for game players and is generally equipped with high-performance hardware assemblies such as a processor, a display card, and a memory, to provide the fluent game experience for the game players. However, these high-performance assemblies may generate a large amount of heat during operation. If the large amount of heat cannot be dissipated in time, the overheating of the notebook computer is caused and thus the performance and the service life of the notebook computer are reduced.

In the related art, a heat sink of the notebook computer is mostly an air-extraction type heat sink, and a fan is disposed in the heat sink of the notebook computer to drive the flow of the air, so as to extract the heat from the notebook computer. However, due to the limited wind power of the fan, the heat dissipation effect is poor, thus affecting the user experience.

### SUMMARY

The present disclosure provides a heat dissipation apparatus.

A heat dissipation apparatus includes a housing, a gas supply member, a gas inlet tube and a vortex tube. The housing has a mounting cavity, a first air outlet, a second air outlet and a first air inlet, where the first air outlet, the second air outlet and the first air inlet communicate with the mounting cavity. The gas supply member is disposed within the mounting cavity. The gas inlet tube has an inlet end abutting against the housing and an outlet end communicating with a gas inlet vent of the gas supply member, and communicates with the first air inlet. The vortex tube has an expansion chamber, a second air inlet, a cold air outlet and a hot air outlet, where the second air inlet, the cold air outlet and the hot air outlet communicate with the expansion chamber. A gas outlet vent of the gas supply member communicates with the second air inlet, the cold air outlet communicates with the first air outlet, and the hot air outlet communicates with the second air outlet. The second air outlet is configured to communicate with a heat dissipation air inlet of an electronic device in response to that the electronic device is placed on the housing.

In some embodiments, the inlet end of the gas inlet tube is of a flared structure and has an inner diameter gradually increasing in a direction towards the first air inlet; and/or a top of the housing has a supporting surface for supporting the electronic device, and the supporting surface is inclined downward from back to front; and/or the housing is provided with at least one of a network interface, a universal serial bus (USB) interface, a high-definition multimedia interface, and a power interface.

In some embodiments, the heat dissipation apparatus further includes a wireless charging assembly, where the wireless charging assembly is disposed in the housing and is configured to wirelessly charge the electronic device.

In some embodiments, the heat dissipation apparatus further includes a distributing tube, where the distributing tube has a distributing inlet, a first distributing outlet and a second distributing outlet, the cold air outlet communicates with the distributing inlet to enable an airflow to flow out from the first distributing outlet and the second distributing outlet, the first distributing outlet communicates with the first air outlet, and the second distributing outlet faces the wireless charging assembly; and/or two gas supply members and two vortex tubes are provided, each of the two gas supply members is connected to a respective one of the two vortex tubes, one of two cold air outlets of the two vortex tubes faces the first air outlet, and the other of the two cold air outlets of the two vortex tubes faces the wireless charging assembly.

In some embodiments, the first air outlet is elongated and extends in a left-right direction, the heat dissipation apparatus further includes an outlet air tube, an inlet of the outlet air tube communicates with the cold air outlet, a position of an outlet of the outlet air tube is adjustable along the left-right direction, and an airflow of the outlet air tube is capable of flowing out from the first air outlet.

In some embodiments, the heat dissipation apparatus further includes a sliding block, where the housing is provided with a sliding groove communicating with the mounting cavity, the sliding groove extends in the left-right direction, the sliding block is slidably disposed in the sliding groove and at least partially extends into the mounting cavity, and the outlet air tube is connected to the sliding block extending into the mounting cavity.

In some embodiments, the outlet air tube is a flexible tube; and/or an end of the sliding block is provided with a friction portion configured for a user to contact.

In some embodiments, the housing includes a bottom base and a support base, the support base and the bottom base are disposed at an included angle, the first air outlet is disposed on the support base, the cold air outlet communicates with the first air outlet through an internal accommodation cavity of the support base, and the support base is configured to support the electronic device.

In some embodiments, the heat dissipation apparatus further includes a wireless charging assembly, where the wireless charging assembly is disposed within the support base and is configured to wirelessly charge the electronic device.

In some embodiments, the bottom base is provided with a limiting engaging groove configured to accommodate the electronic device.

### BRIEF DESCRIPTION OF DRAWINGS

FIG. 1 is a schematic structural diagram of a first angle of view of a heat dissipation apparatus according to one or more embodiments of the present disclosure;

FIG. 2 is a schematic structural diagram of a second angle of view of a heat dissipation apparatus according to one or more embodiments of the present disclosure;

FIG. 3 is a schematic diagram of an internal structure of a heat dissipation apparatus according to one or more embodiments of the present disclosure;

FIG. 4 is an enlarged view at A of FIG. 3;

FIG. 5 is a cross-sectional view of a heat dissipation apparatus according to one or more embodiments of the present disclosure;

FIG. 6 is an enlarged view at B of FIG. 5;

FIG. 7 is a schematic structural diagram of a heat dissipation apparatus according to one or more embodiments of the present disclosure, including two first air outlets;

FIG. 8 is a schematic structural diagram of a heat dissipation apparatus according to one or more embodiments of the present disclosure, including a wireless charging assembly;

FIG. 9 is a schematic structural diagram of a heat dissipation apparatus and a notebook computer according to one or more embodiments of the present disclosure;

FIG. 10 is a schematic structural diagram of a notebook computer according to one or more embodiments of the present disclosure;

FIG. 11 is a schematic structural diagram of a first angle of view of a heat dissipation apparatus according to one or more embodiments of the present disclosure;

FIG. 12 is a schematic structural diagram of a second angle of view of a heat dissipation apparatus according to one or more embodiments of the present disclosure;

FIG. 13 is a cross-sectional view of a heat dissipation apparatus according to one or more embodiments of the present disclosure; and

FIG. 14 is a schematic structural diagram of a heat dissipation apparatus and a mobile phone according to one or more embodiments of the present disclosure.

### LIST OF REFERENCE NUMBERS

1000 electronic device
1100 mobile phone
1200 notebook computer
1210 heat dissipation air inlet
100 housing
101 bottom housing
102 first cover body
1021 groove
103 second cover body
104 supporting surface
110 mounting cavity
120 first air outlet
130 second air outlet
140 first air inlet
150 sliding groove
151 first groove
152 second groove
160 heat dissipation hole
171 bottom base
1711 first accommodation cavity
172 support base
1721 second accommodation cavity
173 limiting engaging groove
181 network interface
182 USB interface
183 high-definition multimedia interface
184 power interface
200 gas supply member
300 vortex tube
310 expansion chamber
320 second air inlet
330 cold air outlet
340 hot air outlet
350 outlet air tube
360 distributing tube
361 first distributing outlet
362 second distributing outlet
400 gas inlet tube
410 inlet end
500 sliding block
510 toggle portion
520 mounting portion
600 wireless charging assembly

### DETAILED DESCRIPTION

The technical solutions of the present disclosure will now be clearly and fully described in conjunction with the accompanying drawings. Apparently, the described embodiments are merely part of embodiments of the present disclosure, rather than all of the embodiments of the present disclosure. All other embodiments obtained by those of ordinary skill in the art based on the embodiments of the present disclosure without requiring creative efforts shall all fall within the scope of protection of the present disclosure.

In the description of the present disclosure, it should be noted that orientations or position relations indicated by terms such as “center”, “upper”, “lower”, “left”, “right”, “vertical”, “horizontal”, “inner” and “outer” are based on orientations or position relations shown in the drawings. These orientations or position relations are intended only to facilitate and simplify the description of the present disclosure and not to indicate or imply that an apparatus or element referred to must have such particular orientations or must be configured or operated in such particular orientations. Thus, these orientations or position relations are not to be construed as limiting the present disclosure. Moreover, terms such as “first” and “second” are used only for the purpose of description and are not to be construed as indicating or implying relative importance. Terms such as “first position” and “second position” are two different positions, and a first feature being “on”, “above” and “over” a second feature includes the first feature being directly above and obliquely above the second feature, or simply indicates that the first feature is at a higher level than the second feature. The first feature being “under”, “below” and “beneath” the second feature includes the first feature being directly below and obliquely below the second feature, or simply indicates that the first feature is at a lower level than the second feature.

In the description of the present disclosure, it should be noted that terms “mounted”, “joined” and “connected” are to be understood in a broad sense unless otherwise expressly specified and limited. For example, the term “connected” may refer to “fixedly connected” or “detachably connected” or “integrally connected”, may refer to “mechanically connected” or “electrically connected” or may refer to “connected directly”, “connected indirectly through an intermediary” or “connected inside two components”. For those of ordinary skill in the art, specific meanings of the preceding terms in the present disclosure may be understood based on specific situations.

The embodiments of the present disclosure will be described in detail below, examples of the described embodiments are shown in the accompanying drawings, where same or similar reference numerals refer to same or similar elements or elements having same or similar functions throughout. The embodiments described below with reference to the accompanying drawings are exemplary, merely serve to explain the present disclosure, and are not to be construed as limiting the present disclosure.

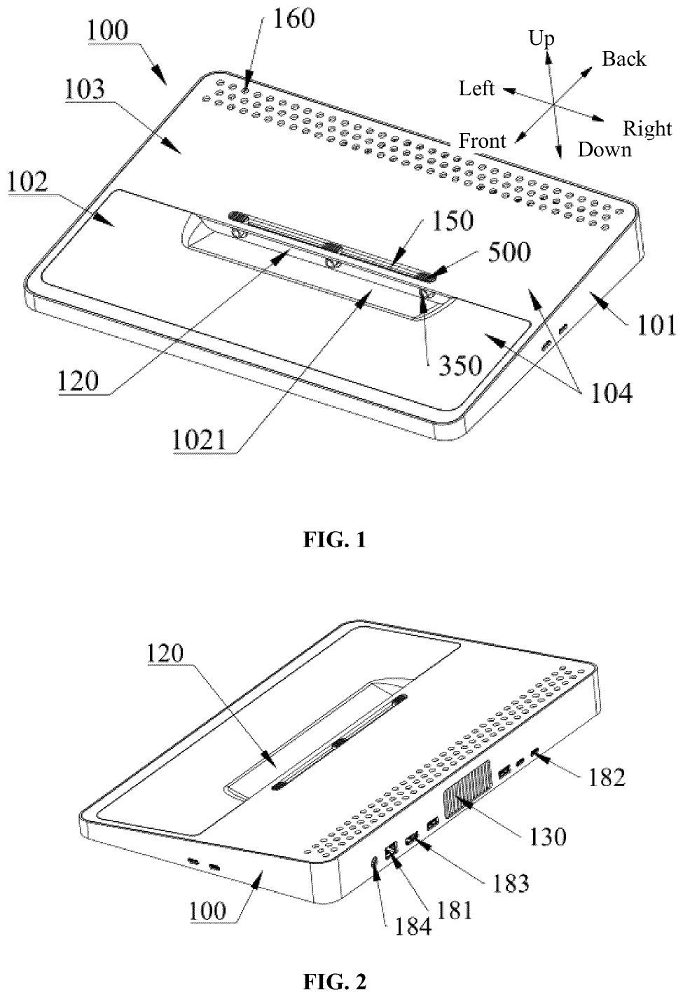

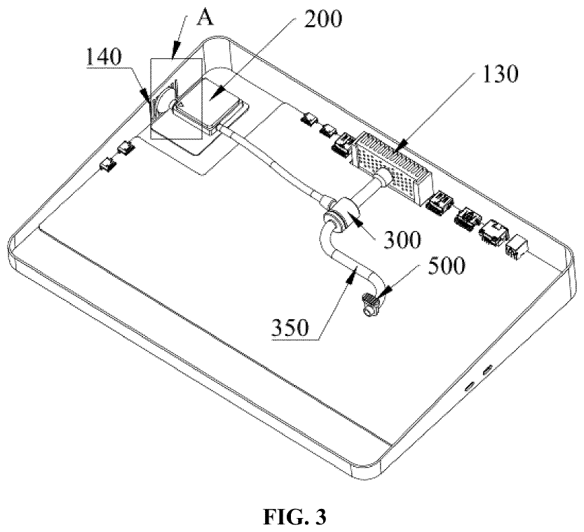

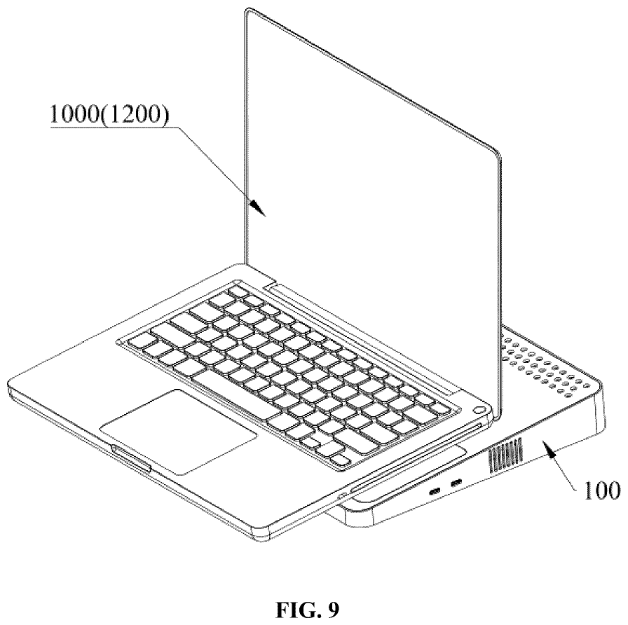

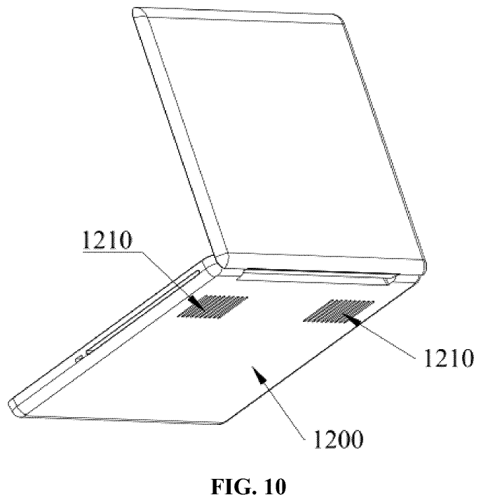

As shown in FIG. 1 to FIG. 10, one or more embodiments provide a heat dissipation apparatus. The heat dissipation apparatus is configured to dissipate heat of an electronic device 1000. In this heat dissipation apparatus, the heat dissipation efficiency is improved and thus the user experience is improved by using a principle of generating cold air by a vortex tube 300.

When gas enters the vortex tube 300, the gas starts to rotate in an expansion chamber 310, and the rotation action divides the gas into two parts, that is, one part is a hot airflow near a wall of the tube, and the other part is a cold airflow near the center.

It specifically includes the following steps.

In a first step, the incoming gas is cooled by expansion to convert heat into rotational kinetic energy, and the total enthalpy (thermal energy+kinetic energy) is conserved in this process.

In a second step, when the peripheral rotating gas moves towards a hot air outlet 340, the heat is transferred from the slower moving axial center flow to the fast moving peripheral flow.

In a third step, a temperature of the rotating air at the hot air outlet 340 is increased, the total enthalpy of the equal amount of gas increases, and the hot gas carries more heat and is discharged to the outside.

In a fourth step, the remaining gas flows to the outlet along the axial center in a reverse direction through the end funnel-shaped adjustment valve. After the gas with a lower total enthalpy passes through a central hole in the expansion chamber 310, this gas leaves a cold air outlet 330 at a lower temperature. The enthalpy is an energy parameter in a thermodynamic system and is represented by the letter H, and the formula is as follows: H=U+pV, where His an enthalpy, U is energy, p is a pressure, and Vis a volume.

In the room temperature air, U and H are each a fixed value. As can be seen from the formula, in the equal amount of air, when p decreases, a value of H decreases. Therefore, when the air enters the expansion chamber 310, the pressure p decreases, the temperature should decrease, but the volume V rises, in this case, a cyclone is generated in the vortex tube 300, in addition, a density of air at an outer ring is high, and a density of air at a center point is low, whereby different pressures are generated in the expansion chamber 310, and the closer to the center, the closer to the vacuum (no pressure). Therefore, energy of H (enthalpy) is converted into the air at the outer ring to form a state of a low temperature (low enthalpy value) at an inner ring and a high temperature (high enthalpy value) at the outer ring. In addition, an output characteristic of the vortex tube 300 is that a center gas with a low temperature and a gas with a high temperature are output separately. Therefore, compressed air may be separated into two streams of airflows, i.e., a stream of cold airflow and a stream of hot airflow, and the cold airflow is guided to a heat dissipation air inlet 1210 of the electronic device 1000, to discharge the hot airflow to the outside, thereby achieving the purpose of heat dissipation.

A heat dissipation apparatus with the vortex tube 300 has the following significant advantages.
(1) The heat dissipation apparatus has no moving parts, no risk of spark, a stable operation, no need of maintenance, but has capacity of producing cold air by air, and high cooling efficiency.
(2) The heat dissipation apparatus can intelligently adjust the flow rate and the temperature of cold air according to the temperature and the load of the electronic device 1000, adapt to different working environments and requirements, and ensure the performance and the service life of a computer, but is not limited thereto.
(3) The heat dissipation apparatus is noiseless during use, is not required to be cleaned due to a fact that no liquid medium exists, does not accumulate the dust due to the outlet air structure, and is simple in structure, small in size, light in weight and convenient to carry.

In this embodiment, the electronic device 1000 may be a mobile phone 1100 or a tablet computer.

With reference to FIG. 1 to FIG. 3, the heat dissipation apparatus includes a housing 100, a gas supply member 200 and a vortex tube 300. The housing 100 has a mounting cavity 110, as well as a first air outlet 120, a second air outlet 130 and a first air inlet 140 that communicate with the mounting cavity 110, that is, the first air outlet 120, the second air outlet 130 and the first air inlet 140 all communicate with the mounting cavity 110. The gas supply member 200 is disposed within the mounting cavity 110 of the housing 100. A gas inlet vent of the gas supply member 200 directly faces the first air inlet 140 and communicates with the first air inlet 140. An airflow outside the housing 100 enters the gas inlet vent of the gas supply member 200 through the second air inlet 320. The vortex tube 300 has an expansion chamber 310, as well as a second air inlet 320, a cold air outlet 330, and a hot air outlet 340 that communicate with the expansion chamber 310. A gas outlet vent of the gas supply member 200 communicates with the second air inlet 320, the cold air outlet 330 communicates with the first air outlet 120, and the hot air outlet 340 communicates with the second air outlet 130. The housing 100 is configured to support the electronic device 1000, and when the electronic device 1000 is placed on the housing 100, the second air outlet 130 communicates with the heat dissipation air inlet 1210 of the electronic device 1000.

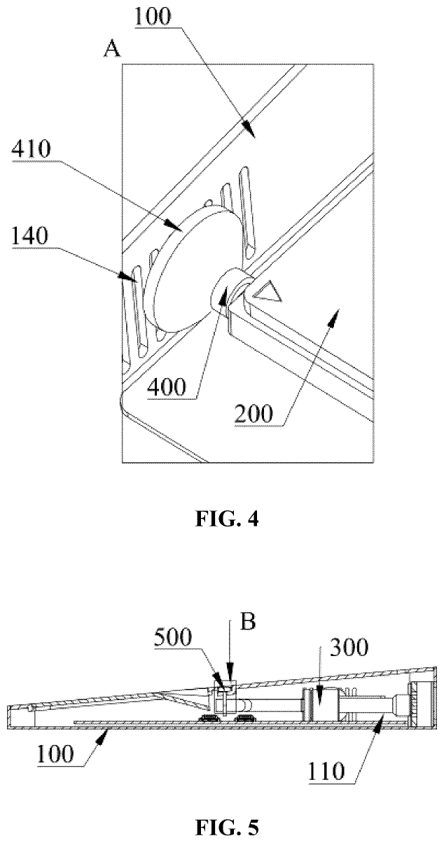

With reference to FIG. 4, in some embodiments, the heat dissipation apparatus further includes a gas inlet tube 400, an inlet end 410 of the gas inlet tube 400 abuts against the housing 100 and communicates with the first air inlet 140, and an outlet end of the gas inlet tube 400 communicates with the gas inlet vent of the gas supply member 200.

In some embodiments, the temperature of the cold air is lower than 0° C., or even lower than −46° C., and the temperature of the hot air is higher than 0° C., or even higher than 100° C. or 127° C. The gas supply member 200 may be a mechanism capable of generating compressed air, such as an air pressure pump or a compressor.

In this embodiment, a temperature of cold air out of the vortex tube 300 is lower than a room temperature, thereby greatly improving the heat dissipation efficiency of the electronic device 1000 and thus improving the user experience.

In addition, since the electronic device 1000 is in contact with the housing 100, a part of heat enters the mounting cavity 110 inside the housing 100, thereby causing a temperature of air within the mounting cavity 110 to be higher than the room temperature. By means of the arrangement of the gas inlet tube 400, an airflow with a higher temperature within the mounting cavity 110 does not enter the gas supply member 200, thereby ensuring that a temperature of an airflow entering the gas supply member 200 is the room temperature, further making a temperature of an airflow flowing out of the cold air outlet 330 of the vortex tube 300 lower, and being conducive to improving the cooling efficiency of the electronic device 1000.

In aerodynamics, the convection is a common manner of heat dissipation, especially in a case where fans or other apparatuses are used to increase the flow of the air. The principle of convection is to generate an airflow on the basis of a density difference of air and to remove the thermal energy from objects or systems with the high temperature. The density difference of the air is mainly determined by the temperature difference of the air and the pressure difference of the air. The greater the temperature difference of the air, the greater the density difference of the air, the faster the velocity of the airflow, and the better the heat dissipation effect. The pressure difference of the air also affects the velocity of the airflow, but the pressure difference of the air is generally less pronounced than the temperature difference of the air in terms of affecting the velocity of the airflow.

The law of cooling may be expressed as the following formula: Q=h*A*T. Q is a heat (heat energy) flux; h is a convection heat transfer coefficient (related to factors such as fluid characteristics and flow speed); A is a surface area; and Tis a temperature difference. This formula indicates that, at a same air volume, if the temperature difference T is relatively large, then the heat flux Q increases correspondingly.

In some embodiments, the inlet end 410 of the gas inlet tube 400 is of a flared structure and has an inner diameter gradually increasing in a direction towards the first air inlet 140. By means of the arrangement of the above-described structure, on the one hand, the airflow can enter the gas inlet tube 400 more smoothly; on the other hand, it may contribute to the generation of vortices, thereby making the temperature of the airflow flowing out from the cold air outlet 330 lower.

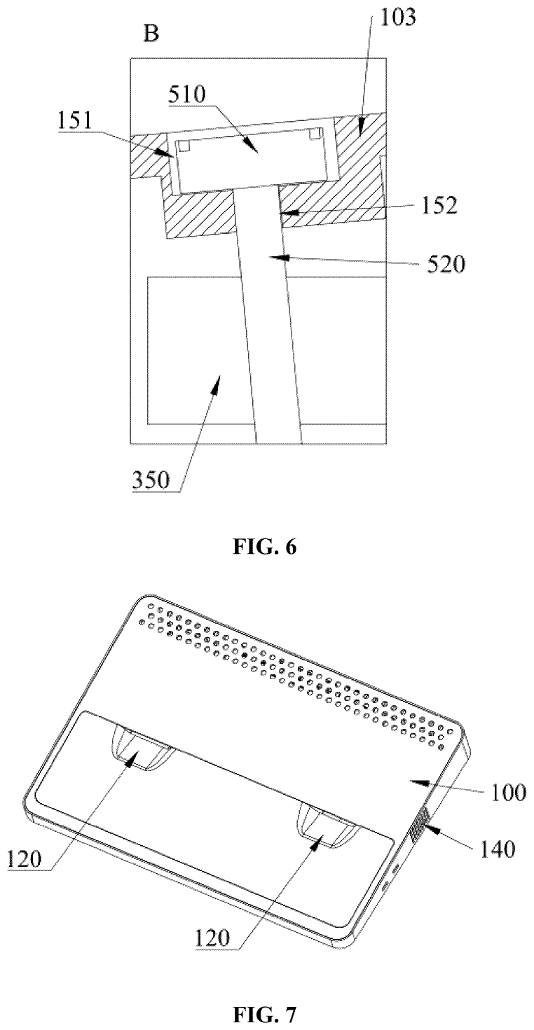

With reference to FIG. 1, FIG. 5 and FIG. 6, positions of the heat dissipation air inlet 1210 may be slightly different for different brands or models of the electronic device 1000. In some embodiments, the first air outlet 120 is elongated and extends in a left-right direction, the heat dissipation apparatus further includes an outlet air tube 350, an inlet of the outlet air tube 350 communicates with the cold air outlet 330, an outlet of the outlet air tube 350 is adjustable in position along the left-right direction, and the airflow in the outlet air tube 350 can flow out from the first outlet air 120. By means of the above-described arrangement, the air outlet position of the cold air can be adjusted, so that different heat dissipation requirements for different positions of the heat dissipation air inlets 1210 of different models of electronic devices 1000 can be satisfied.

In some embodiments, the heat dissipation apparatus further includes a sliding block 500. The housing 100 is provided with a sliding groove 150 communicating with the mounting cavity 110. The sliding groove 150 extends in the left-right direction. The sliding block 500 is slidably disposed in the sliding groove 150 and at least partially extends into the mounting cavity 110. The outlet air tube 350 is connected to the sliding block 500 extending into the mounting cavity 110. By means of the above-described arrangement, it is helpful to change the position of the outlet air tube 350, so that the position of the outlet of the outlet air tube 350 can be adjusted smoothly.

In some embodiments, the sliding block 500 includes a toggle portion 510 and a mounting portion 520 connected to each other. A width of the toggle portion 510 is greater than a width of the sliding groove 150, and a width of the mounting portion 520 is less than a width of the sliding groove 150. The mounting portion 520 passes through the sliding groove 150 and is capable of sliding in the sliding groove 150, and a portion of the mounting portion 520 located within the mounting cavity 110 is configured to fix the outlet air tube 350. The toggle portion 510 is toggled to drive the mounting portion 520 to move, and further drive the outlet of the air outlet tube 350 to move in the left-right direction.

The sliding groove 150 is a countersunk groove, that is, the sliding groove 150 includes a first groove 151 and a second groove 152. The first groove 151 is located above the second groove 152. A width of the first groove 151 is greater than a width of the second groove 152. A width of the toggle portion 510 is greater than the width of the second groove 152 and is less than the width of the first groove 151. The toggle portion 510 is located in the first groove 151, and a top end of the toggle portion 510 is lower than an upper opening of the first groove 151. By means of this arrangement, the toggle portion 510 is located within the first groove 151, and the support of the electronic product by the housing 100 is not affected.

In some embodiments, the mounting portion 520 is provided with a mounting hole, and the outlet air tube 350 is disposed to penetrate into the mounting hole. The outlet air tube 350 is bonded to the mounting hole. The mounting portion 520 is inserted into the second groove 152 and is in friction contact with a hole wall of the second groove 152. By means of this arrangement, a position of the mounting portion 520 relative to the second groove 152 is not changed when no external force is applied, so that the position of outlet air tube 350 can remain unchanged.

For ease of the adjustment of an outlet position of the outlet air tube 350, in this embodiment, the outlet air tube 350 is a flexible tube. The outlet air tube 350 may be made of a rubber material or a plastic material.

For ease of operation, an end of the sliding block 500 is provided with a friction portion configured for a user to contact. In some embodiments, the end of the sliding block 500 is provided with several horizontal stripes, and the horizontal stripes extend in a front-to-back direction.

With reference to FIG. 1, in this embodiment, the housing 100 includes a bottom housing 101, a first cover body 102 and a second cover body 103. Both the first cover body 102 and the second cover body 103 are provided to cover the bottom housing 101, and the bottom housing 101, the first cover body 102 and the second cover body 103 enclose to form the mounting cavity 110. The second cover body 103 is provided with a window, the first cover body 102 is disposed in the window. A groove 1021 is disposed at a rear end of the first cover body 102, and the second cover body 103 is provided to cover a rear end of the groove 1021 at a rear edge of the window, to form the first air outlet 120. The rear end of the first cover body 102 is partially recessed backward and downward to form the groove 1021.

The groove bottom of the groove 1021 is inclined upward from back to front. By means of this arrangement, the cool air flows forward and upward, thereby facilitating the cooling air to enter the heat dissipation air inlet 1210.

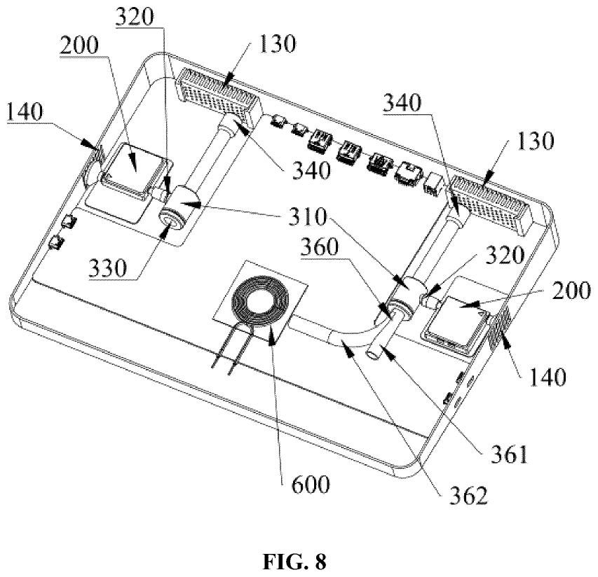

With reference to FIG. 7 and FIG. 8, in some embodiments, the heat dissipation apparatus further includes a wireless charging assembly 600. The wireless charging assembly 600 is disposed in the housing 100 and is configured to wirelessly charge the electronic device 1000. By means of the arrangement of the above-described structure, when the electronic device 1000 is placed on the heat dissipation apparatus, the wireless charging may be performed on the electronic device 1000, thereby improving the convenience of use of the electronic device 1000.

It should be noted that the wireless charging assembly 600 includes a charging coil, and the charging coil cooperates with a receiving coil of the electronic device 1000 to complete the charging of the battery.

In order to avoid that heat generated in the charging process affects the normal operation of the electronic device 1000. In some embodiments, the heat dissipation apparatus further includes a distributing tube 360, and the distributing tube 360 has a distributing inlet, a first distributing outlet 361, and a second distributing outlet 362. The cold air outlet 330 communicates with the distributing inlet, and an airflow flows in from the distributing inlet and can flow out from the first distributing outlet 361 and the second distributing outlet 362. The first distributing outlet 361 communicates with the first air outlet 120, and the second distributing outlet 362 faces the wireless charging assembly 600. By means of the above-described arrangement, the cold airflow flowing out of the cold air outlet 330 may perform the heat dissipation on the electronic device 1000 in a direct convection manner, and may also perform the heat dissipation and temperature-decreasing on the wireless charging assembly 600. When the temperature of the wireless charging assembly 600 is decreased, on the one hand, the charging efficiency can be improved, on the other hand, since the wireless charging assembly 600 is in contact with the housing 100, the wireless charging assembly 600 can absorb part of heat on part of the housing 100. Moreover, since the housing 100 is in contact with the electronic device 1000, the housing 100 with the decreased temperature can absorb part of heat of the electronic device 1000, to perform the temperature-decreasing operation on the electronic device 1000 again in a manner of heat conduction.

In an embodiment in which the wireless charging assembly 600 and the distributing tube 360 are provided, the first air outlet 120 is elongated and extends in the left-right direction, the first air outlet 361 is adjustable in position along the left-right direction, and an airflow in the distributing tube 360 can flow out from the first air outlet 120. In this embodiment, the distributing tube 360 is a three-way tube, and at least a tube with the first distributing outlet 361 of the three-way tube is a flexible tube.

In an embodiment in which the wireless charging assembly 600 is provided, in order to ensure the heat dissipation efficiency, two gas supply members 200 and two vortex tubes 300 are provided, each of the two gas supply members 200 is connected to a respective one of the two vortex tubes 300, and one of two cold air outlets 330 of the two vortex tubes 300 faces the first air outlet 120, and the other of the two cold air outlets 330 of the two vortex tubes 300 faces the wireless charging assembly 600. By means of the above-described arrangement, the heat dissipation is performed for both the electronic device 1000 and the wireless charging assembly 600 simultaneously, and the two gas supply members 200 and the two vortex tubes 300 work simultaneously, so that the heat dissipation efficiency of the wireless charging assembly 600 and the heat dissipation efficiency of the electronic device 1000 are ensured.

In an embodiment in which the wireless charging assembly 600 is provided, in order to ensure the heat dissipation efficiency, two gas supply members 200 and two vortex tubes 300 are provided, each of the two gas supply members 200 is connected to a respective one of the two vortex tubes 300, and two first air outlets 120 are disposed at intervals in the left-right direction. One of two cold air outlets 330 of the two vortex tubes 300 faces the first air outlet 120, and the other of the two cold air outlets 330 of the two vortex tubes 300 blows the cold air to the wireless charging assembly 600 and the other first air outlet 120 through the distributing tube 360. By means of the above-described arrangement, the heat dissipation can be performed for the electronic device 1000 and the wireless charging assembly 600 simultaneously, and the two gas supply members 200 and the two vortex tubes 300 work simultaneously, so that the heat dissipation efficiency of the wireless charging assembly 600 and the heat dissipation efficiency of the electronic device 1000 are ensured. The power of the two gas supply members 200 may be the same or different. In some embodiments, the power of the gas supply member 200 that needs to distributing the cold air to the first air outlet 120 and the wireless charging assembly 600 is greater than the power of the gas supply member 200 that only blows the cold air to the first air outlet 120.

With reference to FIG. 1, in some embodiments, in order to facilitate the heat dissipation of the electronic device in the mounting cavity 110, the housing 100 is provided with several heat dissipation holes 160. The heat dissipation holes 160 are arranged in a matrix manner, so that on the one hand, an overall heat dissipation area can be improved, and on the other hand, it also helps to improve the aesthetic appearance.

In some embodiments, the housing 100 is generally in a rectangular shape, and a notebook computer 1200 is placed on the housing 100. A heat dissipation hole 160 is disposed on a top of the housing 100. The supporting surface 104 on the top of the housing 100 is disposed to be inclined, and is inclined from back to front, where the housing 100 is configured to support the electronic device 1000.

The first air inlet 140 is disposed on the left side of the housing 100. In an embodiment in which two gas supply members 200 are disposed within the housing 100, two first air inlets 140 are provided, and the two first air inlets 140 are disposed on two sides of the housing 100, that is, the two first air inlets 140 are disposed on a left side and a right side of the housing 100, respectively.

In some embodiments, at least one of a network interface 181, a USB interface 182, a high-definition multimedia interface 183, and a power interface 184 is disposed at a rear end of the housing 100. In some embodiments, several network interfaces 181, several USB interfaces 182, and one high-definition multimedia interface 183 are disposed on the rear end of the housing 100. In some embodiments, several network interfaces 181, several USB interfaces 182, one high-definition multimedia interface 183, and one power interface 184 are disposed on the rear end of the housing 100. At least one USB interface of USB interfaces 182 is a Type-C interface. The power interface 184 is configured to be connected to the commercial power, and the heat dissipation apparatus is electrically connected to and/or communicatively connected to the electronic device 1000 through corresponding interfaces.

Beneficial effects of the present disclosure are as follows.

The present disclosure provides the heat dissipation apparatus, in this heat dissipation apparatus, the gas supply member and the vortex tube are disposed within the housing, after the gas of the gas supply member enters the vortex tube, cold air can flow out from the cold air outlet and hot air can flow out from the hot air outlet under the action of the structure of the vortex tube itself. Moreover, the cold air outlet communicates with the first air outlet of the housing, when the electronic device is placed on the housing, the heat dissipation air inlet of the electronic device communicates with the first air outlet, so that the cold air of the vortex tube is blown into the electronic device. Since the temperature of the cold air coming out of the vortex tube is lower than the room temperature, the heat dissipation efficiency of the electronic device is greatly improved, and thus the user experience is improved.

This embodiment has substantially the same result as the above-described embodiments, except for the structure of the housing 100. When the tablet computer or the mobile phone 1100 is used to watch a movie or work, the screen needs to be kept in an inclined state.

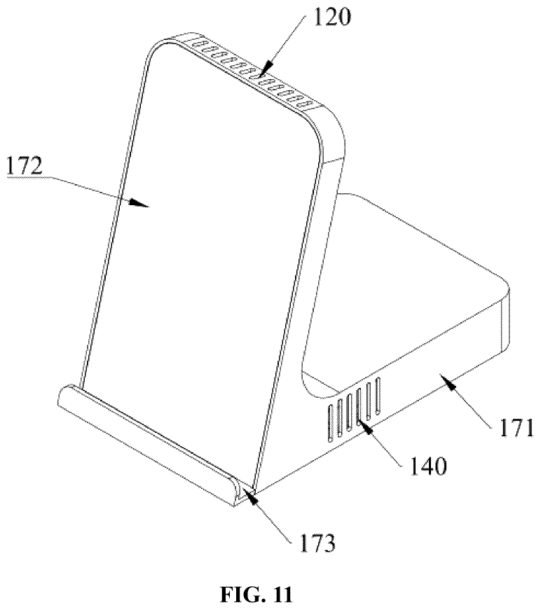

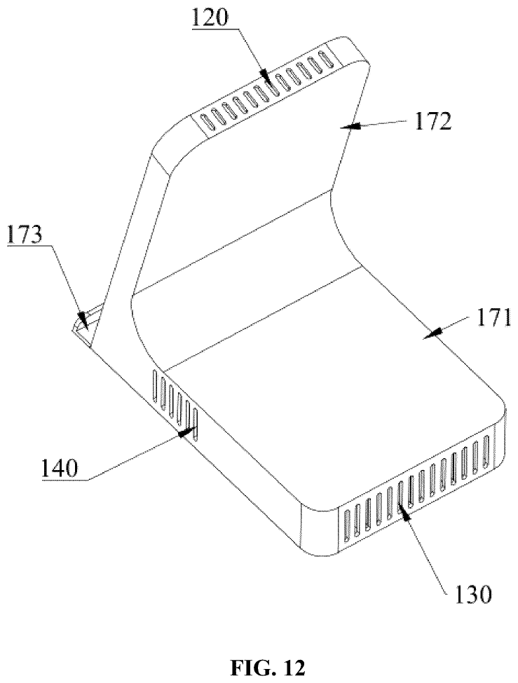

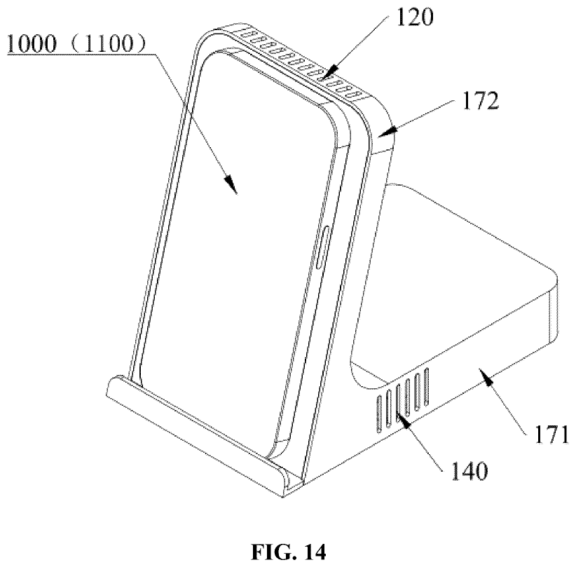

With reference to FIG. 11 to FIG. 14, in this embodiment, the housing 100 includes a bottom base 171 and a support base 172. The support base 172 and the bottom base 171 are disposed at an included angle, the bottom base 171 can be placed on a supporting platform, the second air outlet 130 is disposed on the bottom base 171, the first air outlet 120 is disposed on the support base 172, the cold air outlet 330 communicates with the first air outlet 120 through an internal accommodation cavity of the support base 172, and the support base 172 is configured to support the inclined electronic device 1000. An included angle α between the support base 172 and the bottom base 171 is less than 90°, where a is in a range from 60° to 80°. The supporting platform is a table or other mechanisms with the support surface. By means of the above-described arrangement, the heat dissipation apparatus can support the tablet computer or the mobile phone 1100, and cool the tablet computer or the mobile phone 1100 down.

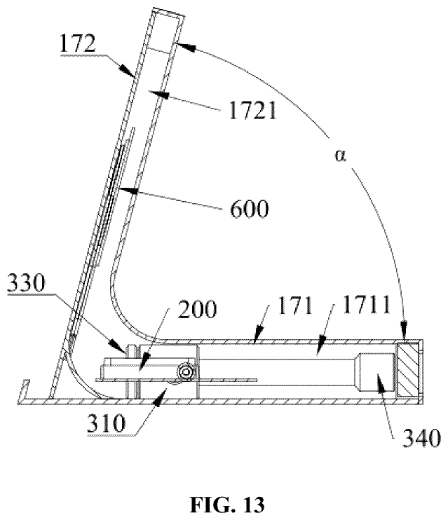

With reference to FIG. 13, in some embodiments, the heat dissipation apparatus further includes a wireless charging assembly 600. The wireless charging assembly 600 is disposed within the support base 172, and the wireless charging assembly 600 is configured to wirelessly charge the electronic device 1000. By means of the above-described arrangement, the heat dissipation apparatus can both cool the electronic device 1000 down and charge the electronic device 1000, thereby improving the convenience of use.

In this embodiment, the bottom base 171 is provided with a first accommodation cavity 1711, and the first accommodation cavity 1711 communicates with the second air outlet 130. The support base 172 is provided with a second accommodation cavity 1721, and the second accommodation cavity communicates with the first air outlet 120. The gas supply member 200 and the vortex tube 300 are disposed in the first accommodation cavity 1711. The cold air outlet 330 of the vortex tube 300 directly faces the second accommodation cavity 1721, and blows the cold air into the second accommodation cavity 1721. By means of the above-described arrangement, the temperature of the support base 172 is decreased, so that the temperature of the electronic device 1000 supported on the support base 172 can be decreased.

In order to prevent the electronic device 1000 from sliding forward, in some embodiments, the bottom base 171 is provided with a limiting engaging groove 173, and the limiting engaging groove 173 is configured to accommodate the electronic device 1000. During use, a lower end of the mobile phone 1100 is placed in the limiting engaging groove 173, and a back of the mobile phone 1100 abuts against the support base 172. The limiting engaging groove 173 extends in the left-right direction. No end stop structure is disposed in the limiting engaging groove 173. By means of this arrangement, the heat dissipation apparatus with the limiting engaging groove 173 can be adapted to electronic devices 1000 with different lengths.

In an embodiment in which the support base 172 is provided, the first air outlet 120 is disposed on a top of the support base 172, the second air outlet 130 is disposed at a rear end of the bottom base 171.

Apparently, the above-described embodiments of the present disclosure are merely examples for clearly illustrating the present disclosure and are not intended to limit the implementation modes of the present disclosure. Other variations or modifications in different forms may be made in light of the above-described description for those of ordinary skill in the art. This need not be, nor should it be exhaustive of all implementation modes.

What is claimed is:

1. A heat dissipation apparatus, comprising:
a housing, having a mounting cavity, a first air outlet, a second air outlet and a first air inlet, wherein the first air outlet, the second air outlet and the first air inlet communicate with the mounting cavity;
a gas supply member, disposed within the mounting cavity;
a gas inlet tube, having an inlet end abutting against the housing and an outlet end communicating with a gas inlet vent of the gas supply member, and communicating with the first air inlet; and
a vortex tube, having an expansion chamber, a second air inlet, a cold air outlet and a hot air outlet, wherein the second air inlet, the cold air outlet and the hot air outlet communicate with the expansion chamber, a gas outlet vent of the gas supply member communicates with the second air inlet, the cold air outlet communicates with the first air outlet, and the hot air outlet communicates with the second air outlet;
wherein the second air outlet is configured to communicate with a heat dissipation air inlet of an electronic device in response to that the electronic device is placed on the housing.

2. The heat dissipation apparatus of claim 1, wherein the inlet end of the gas inlet tube is of a flared structure and has an inner diameter gradually increasing in a direction towards the first air inlet.

3. The heat dissipation apparatus of claim 1, wherein a top of the housing has a supporting surface for supporting the electronic device, and the supporting surface is inclined downward from back to front.

4. The heat dissipation apparatus of claim 1, wherein the housing is provided with at least one of a network interface, a universal serial bus (USB) interface, a high-definition multimedia interface, and a power interface.

5. The heat dissipation apparatus of claim 1, further comprising a wireless charging assembly, wherein the wireless charging assembly is disposed in the housing and is configured to charge the electronic device wirelessly.

6. The heat dissipation apparatus of claim 5, further comprising a distributing tube, wherein the distributing tube has a distributing inlet, a first distributing outlet and a second distributing outlet; and
the cold air outlet communicates with the distributing inlet to enable an airflow to flow out from the first distributing outlet and the second distributing outlet, the first distributing outlet communicates with the first air outlet, and the second distributing outlet faces the wireless charging assembly.

7. The heat dissipation apparatus of claim 5, wherein two gas supply members and two vortex tubes are provided, each of the two gas supply members is connected to a respective one of the two vortex tubes; and
one of two cold air outlets of the two vortex tubes faces the first air outlet, and the other of the two cold air outlets of the two vortex tubes faces the wireless charging assembly.

8. The heat dissipation apparatus of claim 1, wherein the first air outlet is elongated and extends in a left-right direction;
the heat dissipation apparatus further comprises an outlet air tube, an inlet of the outlet air tube communicates with the cold air outlet, a position of an outlet of the outlet air tube is adjustable along the left-right direction, and an airflow in the outlet air tube is capable of flowing out from the first air outlet.

9. The heat dissipation apparatus of claim 8, further comprising a sliding block, wherein the housing is provided with a sliding groove communicating with the mounting cavity, the sliding groove extends in the left-right direction, the sliding block is slidably disposed in the sliding groove and at least partially extends into the mounting cavity, and the outlet air tube is connected to the sliding block.

10. The heat dissipation apparatus of claim 9, wherein the outlet air tube is a flexible tub.

11. The heat dissipation apparatus of claim 9, wherein an end of the sliding block is provided with a friction portion configured for a user to contact.

12. The heat dissipation apparatus of claim 1, wherein the housing comprises a bottom base and a support base, the support base and the bottom base are disposed at an included angle, the first air outlet is disposed on the support base, the cold air outlet communicates with the first air outlet through an internal accommodation cavity of the support base, and the support base is configured to support the electronic device.

13. The heat dissipation apparatus of claim 12, further comprising a wireless charging assembly, wherein the wireless charging assembly is disposed within the support base and is configured to wirelessly charge the electronic device.

14. The heat dissipation apparatus of claim 12, wherein the bottom base is provided with a limiting engaging groove configured to accommodate the electronic device.

15. The heat dissipation apparatus of claim 9, wherein the sliding block comprises a toggle portion and a mounting portion connected to each other, a width of the toggle portion is greater than a width of the sliding groove, and a width of the mounting portion is less than a width of the sliding groove.

16. The heat dissipation apparatus of claim 15, wherein the mounting portion passes through the sliding groove and is capable of sliding in the sliding groove, a portion of the mounting portion located within the mounting cavity is configured to fix the outlet air tube, the toggle portion 510 is toggled to drive the mounting portion to move, and further drive the outlet of the air outlet tube to move in the left-right direction.

17. The heat dissipation apparatus of claim 16, wherein the sliding groove comprises a first groove and a second groove, and the first groove is located above the second groove; and
a width of the first groove is greater than a width of the second groove, and a width of the toggle portion is greater than the width of the second groove and is less than the width of the first groove.

18. The heat dissipation apparatus of claim 17, wherein the toggle portion is located in the first groove, and a top end of the toggle portion is lower than an upper opening of the first groove.

19. The heat dissipation apparatus of claim 17, wherein the mounting portion is provided with a mounting hole, and the outlet air tube is disposed to penetrate into the mounting hole; and
the outlet air tube is bonded to the mounting hole, and the mounting portion is inserted into the second groove and is in friction contact with a hole wall of the second groove.

20. The heat dissipation apparatus of claim 1, wherein the housing comprises a bottom housing, a first cover body and a second cover body, the first cover body and the second cover body are provided to cover the bottom housing;
the bottom housing, the first cover body and the second cover body enclose to form the mounting cavity;
the second cover body is provided with a window, the first cover body is disposed in the window;
a groove is disposed at a rear end of the first cover body, and the second cover body is provided to cover a rear end of the groove at a rear edge of the window, to form the first air outlet; and
the rear end of the first cover body is partially recessed backward and downward to form the groove.
